(19) United States
(12) Patent Application Publication
(10) Pub. No.: US 2016/0285605 A1
(43) Pub. Date: Sep. 29, 2016

(54) Dynamic DM-RS Sequence Selection by PQL Indicator

(71) Applicant: TELEFONAKTIEBOLAGET LM ERICSSON (PUBL), Stockholm (SE)

(72) Inventors: Håkan Andersson, Linköping (SE); Jonas Fröberg Olsson, Ljungsbro (SE); David Hammarwall, Vallentuna (SE); Karl Werner, Segeltorp (SE)

(21) Appl. No.: 15/034,056

(22) PCT Filed: Nov. 20, 2013
(86) PCT No.: PCT/SE2013/051368

§ 371 Date: May 3, 2016

(51) Int. Cl. H04L 5/00

(52) U.S. Cl. CPC H04L 5/0048

(57) ABSTRACT

Methods and apparatus are disclosed for dynamical DM-RS sequence generation in a wireless communications system. The present application discloses that a Physical Downlink Shared Channel (PDSCH) Resource Element (RE) Mapping and Quasi-Co-Location (PQL) indicator can be used to dynamically modify or update the DM-RS sequence generation parameters at a UE. Both the eNB and the UE generate DM-RS reference signals based on the reconfigured parameters. The eNB transmits the generated DM-RS reference signals to the UE to assist the UE in channel estimation.

### TECHNICAL FIELD

The present invention relates generally to generation of demodulation reference signal (DM-RS) sequences and, more specifically, to dynamic configuration of a user equipment (UE) for DM-RS sequence generation.

### BACKGROUND

Downlink reference signals are signals that do not carry user data but are used to aid a user equipment in channel estimation, position estimation, or other functions. One type of downlink reference signals is demodulation reference signals (DM-RS). DM-RS signals are UE-specific reference signals. DM-RS signals contain UE-specific reference symbols that are used to assist a UE in estimating channel conditions needed for coherent demodulation of downlink data.

In an LTE system, an Evolved Node B is configured to generate and transmit different DM-RS sequences. A UE must be informed beforehand of which DM-RS sequence to expect in an up-coming transmission. In practice, a UE is configured by the eNB with one or more configuration parameters that are used by the UE to generate a DM-RS sequence. The UE estimates the channel using one or more received DM-RS signals, which may be transmitted to a UE in a Physical Downlink Shared Channel (PDSCH).

Normally, the one or more configuration parameters used to configure a UE are transmitted via higher-layer signaling, e.g., Radio Resource Control (RRC) signaling. As such, the configuration parameters can't be changed dynamically, for example, on a Transmission Time Interval (TTI) basis. However, in many scenarios, dynamic configuration of a DM-RS sequence generation process is desired. For instance, if at a first time transmission interval, two UEs are configured to receive downlink transmissions on different antenna ports in the same time-frequency resource, the best performance is achieved if the DM-RS sequences of the two transmissions are the same. In this case, the two UEs may be configured to expect the same DM-RS sequence. Both UEs expect the same DM-RS sequence and use knowledge of the transmitted DM-RS sequence to process the DM-RS signal for channel estimation. In a different scenario, if at a second Transmission Time Interval (TTI) the two UEs are scheduled to receive downlink transmissions on the same antenna port and on the same time-frequency resource, in order to mitigate interference, different DM-RS sequences should be used in the DM-RS signals intended for these two UEs. In such case, the UEs should be re-configured to expect different DM-RS sequences. The current technique does not allow re-configuration of a UE to generate different DM-RS sequences on a TTI basis.

There is a need for improved methods and apparatus that can be used to dynamically configure UEs for DM-RS sequence generation.

### SUMMARY

The present invention provides methods and apparatus for dynamically configuring UEs with parameters for DM-RS sequence generation.

In some embodiments, a method for generating a demodulation reference signal (DM-RS) sequence is implemented at a user equipment in a wireless communications network. In the method, the user equipment receives a Physical Downlink Shared Channel (PDSCH) Resource Element (RE) Mapping and Quasi-Co-Location (PQL) indicator from an eNB. The user equipment generates a DM-RS sequence from the received PQL indicator. The generated DM-RS sequence is used by the UE to process one or more DM-RS signals that are received from the eNB. The one or more received DM-RS signals are used by the UE to estimate a channel. In some embodiments, the UE comprises a transceiver for communicating with an eNB, a memory for storing data, and processors configured to generate a DM-RS sequence based on a received PQL indicator.

In some embodiments, a method for configuring a UE for dynamic DM-RS sequence generation is implemented at an eNB. The eNB is configured with one or more PQL indicators. The eNB determines a PQL indicator for a UE. The PQL indicator is associated with one or more DM-RS sequences. The eNB transmits the PQL indicator to the UE and also generates a DM-RS signal using a DM-RS sequence associated with the determined PQL indicator. The DM-RS signal is then transmitted to the UE for channel estimation. In some embodiments, the eNB comprises a transceiver configured for communicating with user equipment, a memory configured for storing data, and a processor configured to send a PQL indicator to a UE for configuring the UE for dynamic DM-RS sequence generation.

Of course, the present invention is not limited to the features, advantages, and contexts summarized above, and those familiar with wireless communication technologies will recognize additional features and advantages upon reading the following detailed description and upon viewing the accompanying drawings.

### BRIEF DESCRIPTION OF THE DRAWINGS

FIG. 1 illustrates an exemplary wireless communication system configured for generating and transmitting downlink DM-RS sequences.

FIG. 2 illustrates an exemplary table mapping different PQL indicators to DM-RS indices.

FIG. 3 illustrates an exemplary data structure of a PDSCH RE Mapping parameter set.

FIG. 4 illustrates an exemplary mobile device configured for dynamic DM-RS sequence generation.

FIG. 5 illustrates a flow chart of an exemplary process for dynamic DM-RS sequence generation at a mobile device.

FIG. 6 illustrates an exemplary eNB configured to send a PQL indicator for configuring a UE for dynamic DM-RS sequence generation.

FIG. 7 illustrates a flow chart of an exemplary process implemented at an eNB for configuring a UE for dynamic DM-RS sequence generation.

### DETAILED DESCRIPTION

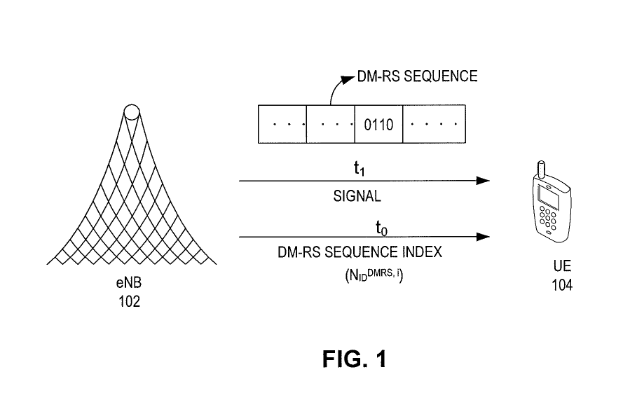

Referring now to the drawings, FIG. 1 illustrates an exemplary wireless communications system 100 that includes an eNB 102 and a UE 104. In FIG. 1, the eNB 102 transmits data to the UE 104 on the downlink radio connection. In order to perform demodulation of the received data, the UE 104 must calculate an estimate of the radio channel through which the received data has just propagated. To assist the UE 104 to estimate a channel, the eNB 102 transmits UE-specific reference signals to the UE 104 for use in channel estimation. The UE 104 has prior knowledge of what reference signals to expect. By comparing the reference signals actually received with the transmitted reference signals, the UE 104 can generate an estimate of the channel condition.

In an LTE system, one type of UE-specific reference signals is DM-RS signals. A DM-RS signal comprises a DM-RS sequence, which is generated as a pseudo-random sequence c(i). In one exemplary standard, the pseudo-random sequence generator is initialized as shown below:

cᵢₙᵢₜ=([nₛ/2]+1)·(2n_{ID}⁽ⁿ^{_{SCID}}⁾+1)·2¹⁶+n_{SCID},

prior to generating the DMRS sequence for a specific radio subframe. Here:
nₛ is the slot number within the specific radio subframe;
n_{SCID} may be of value 1 or 0;
for i=0, or 1,
   n_{ID}ⁱ=N_{ID}^{cell}, if no value of n_{ID}^{DMRS,i} is provided by higher layers or if DCI format 1A, 2B or 2C is used for the DCI associated with the PDSCH transmission, where N_{ID}^{cell} is the physical cell identity;
   n_{ID}ⁱ=n_{ID}^{DMRS,i} otherwise.
      The initial value of a DM-RS sequence, Cᵢₙᵢₜ, depends on two variables, n_{ID}⁽ⁿ^{_{SCID}}⁾ and n_{SCID}. Given the same values of n_{ID}⁽ⁿ^{_{SCID}}⁾ and n_{SCID}, the same initial value of a DM-RS sequence will be generated. The same initial value produces the same DM-RS sequence, assuming the same slot value, nₛ. If two UEs are given the same value of n_{ID}⁽ⁿ^{_{SCID}}⁾ and n_{SCID}, they will generate the same DM-RS sequence in a given slot.

Whether the parameter n_{SCID} takes the value of 1 or 0 is signaled as part of the downlink scheduling information on the downlink control channel and can be reconfigured on a fast time scale, e.g., on a TTI basis.

The parameter n_{ID}⁽ⁿ^{_{SCID}}⁾ can take two values, either the physical cell identity, N_{ID}^{cell}, or n_{ID}^{DMRS,i}. The former is fixed and its value is stored at the UE 104 when the UE 104 initially establishes a radio connection with the eNB 102. The latter is a UE-specific parameter with a large value range. The parameter n_{ID}^{DMRS,i} essentially determines the initial value of a DM-RS sequence, cᵢₙᵢₜ, which determines the entire DM-RS sequence. For this reason, n_{ID}^{DMRS,i} is also i referred to as the DM-RS sequence index in the present application.

Both the eNB 102 and the UE 104 use the same mathematical formula shown above to generate DM-RS sequences. The eNB 102 generates a DM-RS sequence and transmits the generated sequence as a DM-RS signal. To inform the UE 104 what DM-RS sequence to expect, it is sufficient for the eNB 102 to send the UE 104 parameter n_{ID}^{DMRS,i}. However, n_{ID}^{DMRS,i} is usually sent to the UE 104 via signaling over higher layers, for example, radio link layer. As such, n_{ID}^{DMRS,i} normally can't be changed on a fast time scale.

In some embodiments, all UEs associated with a given eNB or transmission entity may be assigned the same value for n_{ID}^{DMRS,i}, in effect making the DM-RS reference transmission-entity specific. All UEs associated with the same physical cell identifier will expect and indeed receive the same DM-RS signal. While planning is relatively easy when all UEs associated with the same transmission entity are given the same n_{ID}^{DMRS,i}, a UE can't dynamically switch from one eNB to another because switching from one eNB to another requires higher layer signaling that is utilized to transmit the value of n_{ID}^{DMRS,i}.

In some embodiments, n_{ID}^{DMRS,i} may be configured to be UE-specific. When generating a DM-RS sequence, the eNB 102 selects the n_{ID}^{DMRS,i} associated with the UE scheduled at that particular time interval. In these embodiments, the UEs do not require dynamic configuration. However, whenever reconfiguration of the UEs is required, for example, when the radio environment or traffic situation has changed, the reconfiguration process is complex and involves coordination among several eNBs.

In some embodiments, n_{ID}^{DMRS,i} may be signaled to a UE as part of the downlink control information. However, this approach has several drawbacks. First, without decoding the control information that is used by the UE to obtain the DM-RS sequence index, n_{ID}^{DMRS,i}, the UE will not be able to generate a DM-RS sequence and can't perform any computations that depend on the DM-RS sequence. Second, the DCI format used to transmit control information must be changed to add extra bits to hold n_{ID}^{DMRS,i}. Changing the DCI format in a downlink control message may render the downlink control message incompatible with the current standard.

In some embodiments, instead of downlink control information, the DM-RS sequence index n_{ID}^{DMRS,i} is transmitted to the UE 104 using Physical Downlink Shared Channel (PDSCH) Resource Element (RE) Mapping and Quasi-Co-Location Indicator (PQL Indicator). In an LTE-Advanced system, a Physical Downlink Shared Channel (PDSCH) carries user information and signaling originated from upper layers of protocol stack, e.g., a transport layer. PDSCH has different adaptation modes or transmission hypotheses that are defined by a set of parameters. Multiple PQL parameter sets may be transmitted to the UE 104 and stored at the UE 104 via higher-layer signaling. Because the eNB 102 may change its transmission mode dynamically, the eNB 102 must dynamically signal the UE 104 which transmission mode is used for an upcoming downlink transmission or which parameter set is associated with the upcoming downlink transmission. Downlink control information (DCI) is used for this purpose. DCI includes the modulation and coding scheme, the transport block size, etc., used in the upcoming transmission. DCI also includes a PQL indicator. The PQL indicator informs the UE 104 the parameter set associated with the upcoming downlink transmission over a Physical Downlink Shared Channel (PDSCH).

In some embodiments, a PQL indicator is used to indicate to the UE 104 which parameter set is associated with the scheduled PDSCH transmission. The PQL indicator is included in the DCI transmitted over a Physical Downlink Control Channel (PDCCH) or enhanced Physical Downlink Control Channel (ePDCCH). The PDCCH or the ePDCCH are transmitted in conjunction with the PDSCH transmission.

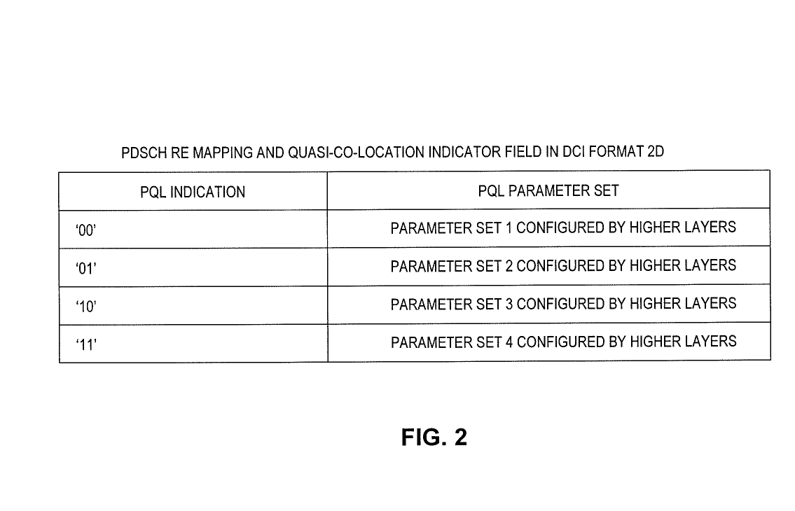

FIG. 2 illustrates an example of a mapping between different values of a PQL indicator and different parameter sets associated with a PDSCH transmission. In FIG. 2, the PQL indicator is a 2-bit variable and can have four different values. When the UE 104 decodes the PDCCH and determines that the PQL indicator is ‘00’, the UE 104 processes the corresponding PDSCH transmission using “parameter set 1,” according to FIG. 2. Similarly, when the UE 104 determines that the PQL indicator included in the DCI is ‘01’, the UE 104 uses parameter set 2 to process the corresponding PDSCH transmission.

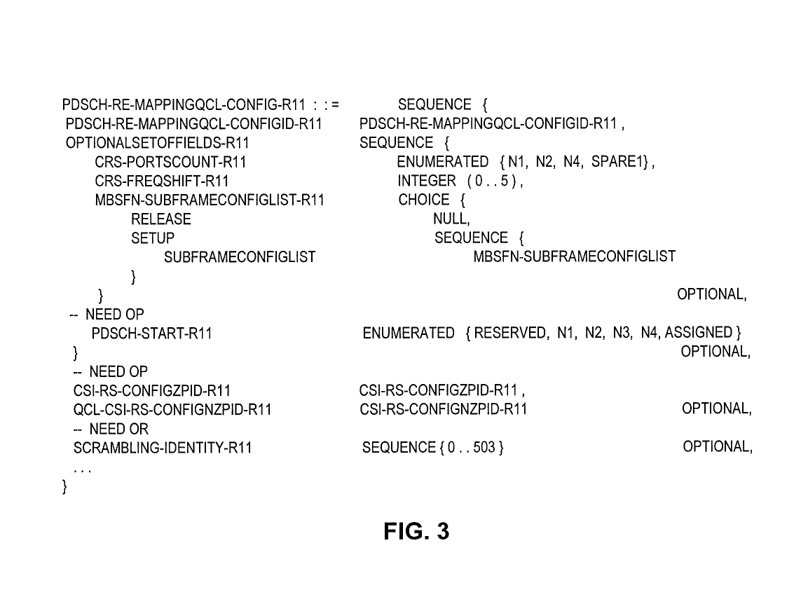

FIG. 3 illustrates an exemplary PQL parameter set that the UE 104 can use to process a PDSCH transmission. The PQL parameter set includes parameters such as the number of antenna ports (crs-PortsCount-r11), frequency shift (crs-FreShift-r11), MBSFN subframe configuration (mbsfn-SubframeConfigList-r11), PDSCH starting position (pdsch-Start-r11), CSI_RS resource configuration identity (qcl-CSI-RS-ConfigNZPID-r11), etc. These parameters determine the PDSCH resource element mapping and the PDSCH antenna port quasi co-location configuration.

The PQL indicator or the associated PQL parameter set can be used to configure a UE for dynamic DM-RS sequence generation.

In some embodiments, parameter n_{SCID} is fixed (0 or 1). It may be transmitted to the UE or simply disregarded for DM-RS sequence generation. In some embodiments, parameter n_{SCID} may be removed from DCI altogether. When parameter n_{SCID} is fixed, the initial value of a DM-RS sequence, cᵢₙᵢₜ, can be computed using the following simplified expression:

([nₛ/2]+1)·(2n_{ID}+1)·2¹⁶.

Here cᵢₙᵢₜ depends on n_{ID} and nₛ only. But only n_{ID} needs to be signaled to the UE for DM-RS sequence generation. If the values of n_{ID} are mapped to the values of the PQL indicator, the UE 104 can retrieve the value of n_{ID} based on the PQL indicator included in the DCI received over the PDCCH channel. The UE 104 then uses the retrieved n_{ID} to compute cᵢₙᵢₜ, and uses cᵢₙᵢₜ to generate a DM-RS sequence.

It is noted that although only four parameter sets are shown in FIG. 2, the number of PQL parameter sets can be extended. For example, the PQL indicator field in FIG. 2 may be expanded from 2 bits to 3 bits. In such case, eight parameter sets can be supported. In order to expand the PQL indicator field, the DCI format needs to be changed. For example, the n_SCID bit in the DCI format may be re-used to expand the PQL Indicator field from 2 bits to 3 bits. The advantage of having a larger set of PQL parameter sets is that more transmission hypotheses can be supported and the eNB 102 has more choices in selecting a PQL parameter set for downlink transmissions that suits both the eNB 102 and the UE 104.

In some embodiments, a parameter set may be expanded to include a field for holding the value of n_{ID}^{DMRS,i}. The UE 104 receives a PQL indicator in a DCI message over the PDCCH channel. The UE 104 maps the PQL indicator to a parameter set and retrieves the parameter set that has been previously configured. The retrieved parameter set includes a field that holds the value of n_{ID}^{DMRS,i}, which the UE uses to generate a DM-RS sequence.

As described above, downlink control information (DCI) associated with each downlink shared channel (DL-SCH) transmission is signaled to the UE 104 in conjunction with the DL-SCH transmission. The PQL indicator is included in the DCI to be dynamically signaled to the UE 104. By mapping the different values of the PQL indicator to different values of n_{ID}^{DMRS,i}, the UE 104, which generates DM-RS sequences using n_{ID}^{DMRS,i}, can be dynamically configured.

The mapping between the different values of the PQL indicator and the different values of n_{ID}^{DMRS,i} can be provided to the UE using higher-layer signaling on a relatively slow time scale, for example, over a radio link control layer. The mapping can be updated or revised to associate different DM-RS sequences with a given UE.

In some embodiments, a mapping table is transmitted to the UE by the eNB serving the UE. The mapping table provides the mapping between the different values of the PQL indicator and the different values of n_{ID}^{DMRS,i}. In some embodiments, the mapping table may be provided to the UE by a network node other than the serving eNB.

In some embodiments, two UEs may be provided with the same mapping between the PQL indicator and the DM-RS sequence index n_{ID}^{DMRS,i}. Depending on whether the two UEs are receiving on different ports, the eNB 102 may configure the two UEs to generate the same DM-RS sequence or different DM-RS sequences by selecting the PQL indicator transmitted in the DCI.

Also depending on whether the two UEs are receiving on the same time-frequency resource block, the eNB 102 may configure the two UEs to generate the same DM-RS sequence or different DM-RS sequences by selecting the PQL indicator transmitted in the DCI. Co-scheduling of two UEs on the same time-frequency resource are dependent on various factors, e.g., traffic patterns, radio channel conditions, etc. As such, co-scheduling is highly dynamic and dynamic configuration of a DM-RS sequence generation process at a UE 104 makes co-scheduling possible. In some embodiments, the eNB 102 coordinates with other network nodes in configuring the DM-RS sequence generation process at a UE. The coordination among different nodes can be utilized to implement other features, such as dynamic point selection, joint transmission, and Coordinated Multiple-Point (CoMP).

In some embodiments, the eNB 102 selects a PQL indicator for the UE 104 in order to generate an optimal DM-RS sequence for the UE 104. An optimal DM-RS sequence for the UE 104 may be different under different scenarios, depending on whether it is joint transmission or CoMP, etc. For example, the eNB 102 may generate a DM-RS sequence for the UE 104 that is orthogonal to the DM-RS sequences generated for all the other UEs in the same network. In some embodiments, the same network may refer to the network of the eNB 102. In other embodiments, the same network may refer to the network comprising the network nodes with which the eNB 102 is coordinating. For another example, the eNB 102 may generate a DM-RS sequence for the UE 104 that is identical to the DM-RS sequence generated for another UE.

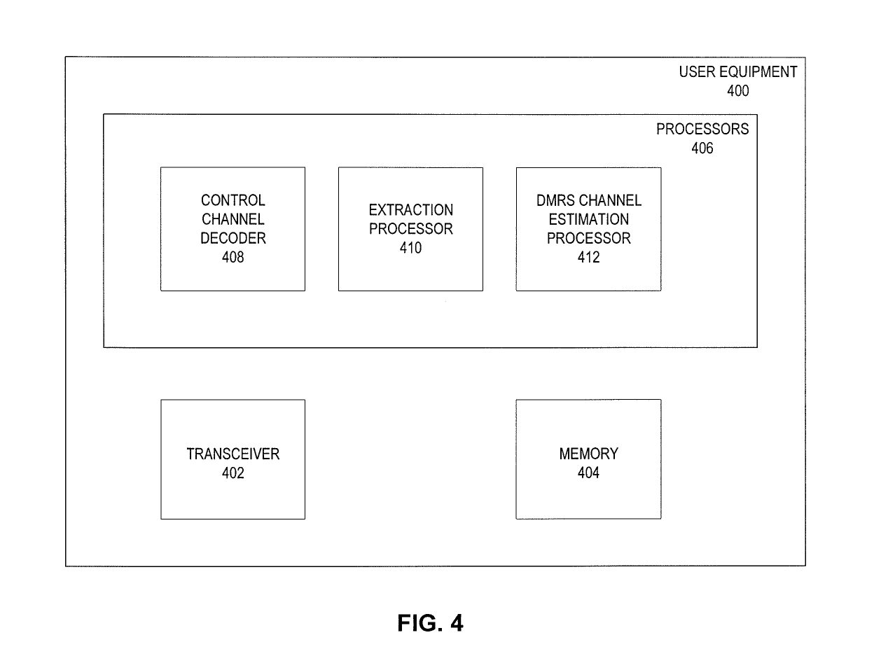

FIGS. 4-7 depict exemplary UE 104 and eNB 102 that are configured for dynamic DM-RS sequence generation.

In FIG. 4, a UE 400 is shown to comprise a transceiver 402, a memory 404, and processors 406. The transceiver 402 is configured for communicating with an eNB. The memory 404 is configured for storing data. The processor is 406 is configured for dynamic DM-RS generation.

The processors 406 further comprise a control channel decoder 408, an extraction processor 410, and a DM-RS channel estimation processor 412. The control channel decoder 408 decodes the PDCCH or ePDCCH and retrieves a PQL indicator. The retrieved PQL indicator is input to the extraction processor 410, which maps the retrieved PQL indicator to a DM-RS sequence index. The DM-RS sequence index is input to the DM-RS channel estimation processor 412. The DM-RS channel estimation processor 412 uses the DM-RS sequence index to generate a DM-RS sequence which is used to process the one or more DM-RS signals transmitted by the eNB to the UE. The detected DM-RS signals are used for channel estimation.

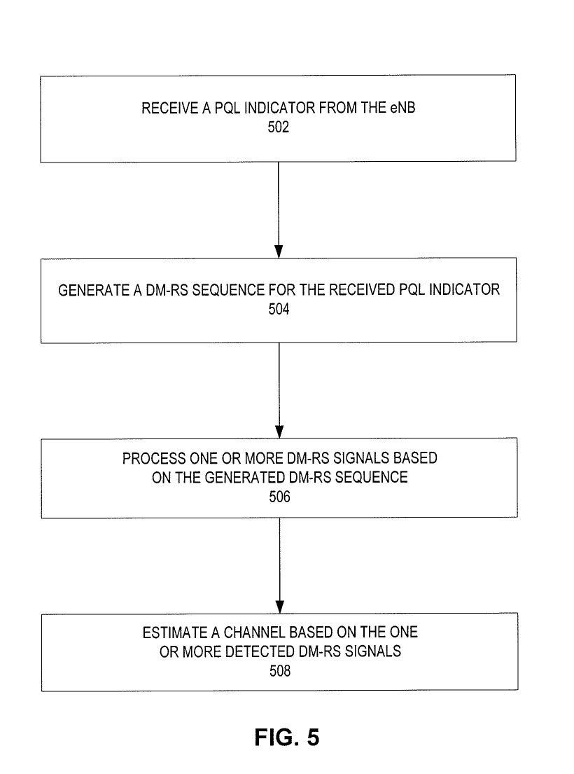

FIG. 5 illustrates a flow chart of an exemplary process executed by the processors 406. The processors 406 receive a PQL indicator from the eNB 102 (step 502), and generate a

DM-RS sequence from the received PQL indicator (step 504). The processors 406 then processes one or more DM-RS signals based on the generated DM-RS sequence (step 506). The one or more DM-RS signals are transmitted by the eNB 102 and received by the mobile device 400. The processors 406 estimate a channel based on the one or more detected DM-RS signals (step 508).

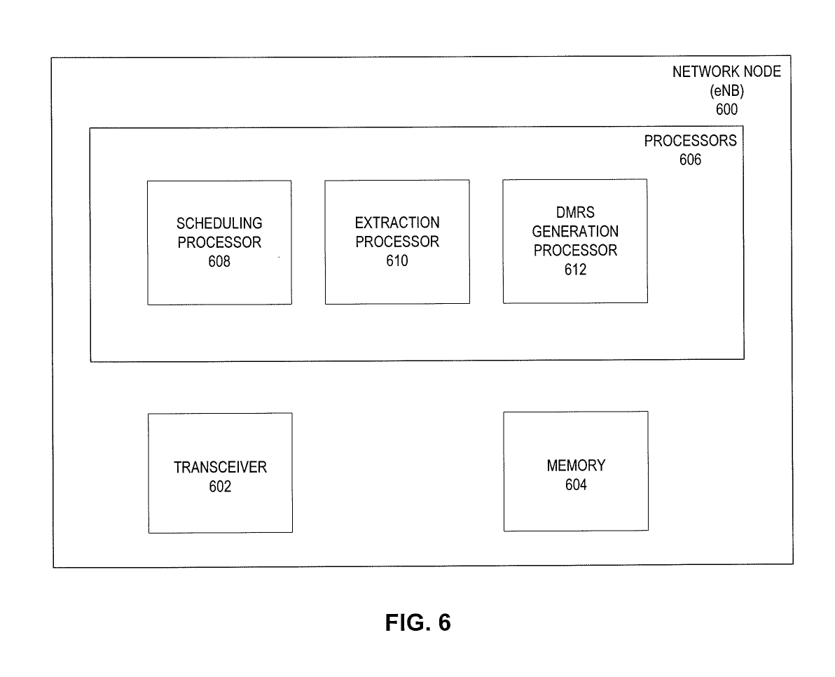

FIG. 6 illustrates an exemplary network node 600, e.g., the eNB 102, configured for dynamic DM-RS sequence generation. The network node 600 comprises a transceiver 602, a memory 604, and processors 606. The transceiver 602 is configured for communicating with a UE 400. The memory 604 is configured for storing data. The processors 606 further comprise a scheduling processor 608, an extraction processor 610, and a DM-RS generation processor 612.

The scheduling processor 608 schedules downlink transmissions for different mobile devices. The downlink scheduling information (DCI) is transmitted to a UE 400 via the PDCCH or ePDCCH. The DCI may include a PQL indicator informing the UE 400 which PQL parameter set is associated with the PDSCH transmission. The PQL indicator is input into the extraction processor 610, which maps the PQL indicator to a DM-RS sequence index. In one embodiment, the PQL indicator may be mapped to one or more DM-RS sequence indices. The DM-RS sequence indices are input into the DMRS generation processor 612, which may select one DM-RS sequence index to generate a DM-RS sequence. The generated DM-RS sequence is transmitted as a DM-RS signal to the UE 400.

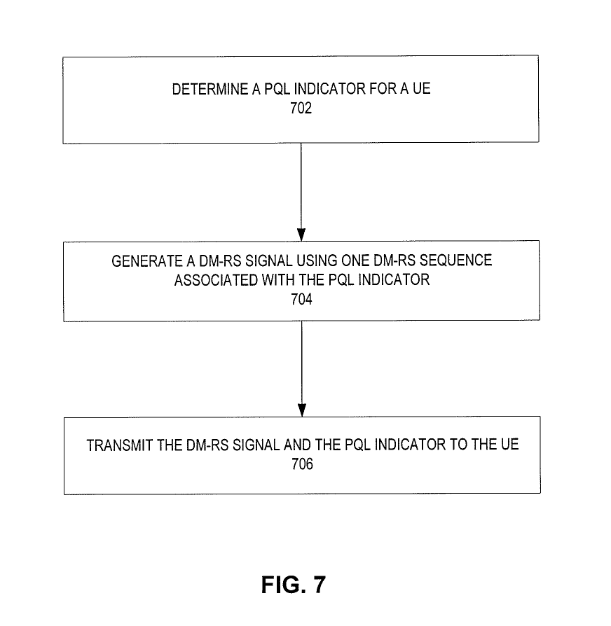

FIG. 7 is a flow chart illustrating an exemplary process implemented at the network node 600 for dynamically generating a DM-RS sequence. In FIG. 7, the network node 600 determines a PQL indicator for a user equipment (step 702). A UE-specific association between the PQL indicator and one or more DM-RS sequences is provided. The network node 600 also generates a DM-RS signal using one of the one or more DM-RS sequences associated with the

PQL indicator (step 704). The PQL indicator and the generated DM-RS signal are transmitted to the UE (step 706). In some embodiments, the PQL indicator and the generated DM-RS signal may be transmitted separately. In some embodiments, the PQL indicator and the generated DM-RS signal may be transmitted in a same OFDM symbol.

The foregoing description and the accompanying drawings represent non-limiting examples of the methods and apparatus taught herein. As such, the present invention is not limited by the foregoing description and accompanying drawings. Instead, the present invention is limited only by the following claims and their legal equivalents.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1-34. (canceled)

35. A method, implemented at a user equipment (UE) in a wireless communications network, for generating a demodulation reference signal (DM-RS) sequence to be used in channel estimation, the method comprising:
receiving a Physical Downlink Shared Channel (PDSCH) Resource Element (RE) Mapping and Quasi-Co-Location (PQL) indicator from an Evolved Node B (eNB);
generating the DM-RS sequence from the received PQL indicator;
processing one or more received DM-RS signals based on the generated DM-RS sequence, wherein the one or more received DM-RS signals are transmitted by the eNB; and
estimating a channel based on the one or more received DM-RS signals.

36. The method of claim 35, wherein the generating the DM-RS sequence from the received PQL indicator comprises:
retrieving a DM-RS sequence index associated with the received PQL indicator from a mapping table, wherein the mapping table is received from a network node and maps each of one or more PQL indicators to a respective DM-RS sequence index; and
using the retrieved DM-RS sequence index as a seed to generate the DM-RS sequence.

37. The method of claim 35, wherein the generating the DM-RS sequence from the received PQL indicator comprises:
receiving a parameter from the eNB;
determining a DM-RS sequence index based on the received parameter, the received PQL indicator, and a mapping table; wherein the mapping table is received from a network node and maps each of one or more PQL indicators to one or more DM-RS sequence indices; wherein the received parameter is used to select the determined DM-RS sequence index from the one or more DM-RS sequence indices mapped to the received PQL indicator; and
using the determined DM-RS sequence index as a seed to generate the demodulation reference signal.

38. The method of claim 36, further comprising receiving a reconfigured mapping table from the network node or a different network node via signaling over a Radio Resource Control (RRC) layer, wherein the reconfigured mapping table provides a different mapping between one or more PQL indicators and one or more DM-RS sequence indices.

39. The method of claim 35, wherein the generating the DM-RS sequence from the received PQL indicator comprises retrieving a PQL parameter set using the received PQL indicator, wherein the retrieved PQL parameter set is transmitted by the eNB and includes a DM-RS sequence index that can be used as a seed to generate the DM-RS sequence.

40. The method of claim 39, further comprising receiving a reconfigured PQL parameter set from the eNB via signaling over a Radio Resource Control (RRC) layer, wherein the reconfigured PQL parameter set includes a different DM-RS sequence index.

41. A user equipment, comprising:
a transceiver configured to communicate with an Evolved Node B (eNB);
memory for storing data; and
one or more processors configured to:
receive a Physical Downlink Shared Channel (PDSCH) Resource Element (RE) Mapping and Quasi-Co-Location (PQL) indicator from the eNB via the transceiver;
generate a demodulation reference signal (DM-RS) sequence from the received PQL indicator;
process one or more received DM-RS signals based on the generated DM-RS sequence, wherein the one or more received DM-RS signals are received from the eNB via the transceiver; and
estimate a channel using the one or more received DM-RS signals.

42. The user equipment of claim 41:
wherein the generating the DM-RS sequence from the received PQL indicator comprises one process of process A, process B, and process C;
wherein process A comprises:
retrieving a DM-RS sequence index associated with the received PQL indicator from a mapping table, wherein the mapping table is received from a network node and maps each of one or more PQL indicators to a respective DM-RS sequence index; and
using the retrieved DM-RS sequence index as a seed to generate the DM-RS sequence;
wherein process B comprises:
receiving a parameter from the eNB;
determining a DM-RS sequence index based on the received parameter, the received PQL indicator, and a mapping table; wherein the mapping table is received from a network node and maps each of one or more PQL indicators to one or more DM-RS sequence indices; wherein the received parameter is used to select the determined DM-RS sequence index from the one or more DM-RS sequence indices mapped to the received PQL indicator; and
using the determined DM-RS sequence index as a seed to generate the demodulation reference signal.
wherein process C comprises:
retrieving a PQL parameter set using the received PQL indicator, wherein the retrieved PQL parameter set is transmitted by the eNB and includes a DM-RS sequence index that can be used as a seed to generate the DM-RS sequence.

43. A method, implemented by an Evolved Node B (eNB) in a wireless communications network, the eNB being configured with one or more Physical Downlink Shared Channel (PDSCH) Resource Element (RE) Mapping and Quasi-Co-Location (PQL) indicators, the method comprising:
determining a PQL indicator for a user equipment (UE), wherein a UE-specific association is provided between the PQL indicator and one or more demodulation reference signal (DM-RS) sequences;
generating one of the one or more DM-RS sequences associated with the determined PQL indicator; and
transmitting the PQL indicator and the generated DM-RS sequence to the UE.

44. The method of claim 43, further comprising transmitting a parameter to the UE to signal which one of the one or more DM-RS sequences associated with the PQL indicator is generated.

45. The method of claim 43, wherein the determining the PQL indicator is performed to generate an optimal DM-RS sequence for the UE.

46. The method of claim 45, wherein the optimal DM-RS sequence for the UE is a DM-RS sequence orthogonal to any DM-RS sequences concurrently transmitted to other UEs in a same network.

47. The method of claim 43, wherein the determining the PQL indicator is performed to generate an optimal set of communication parameters for the UE, the optimal set of communication parameters including a DM-RS sequence.

48. The method of claim 43:
wherein the UE-specific association between the PQL indicator and the DM-RS sequence is stored in a UE-specific mapping table;
wherein the UE-specific mapping table maps each of the one or more PQL indicators to one or more DM-RS sequence indices and each of the one or more DM-RS sequence indices can be used as a seed to generate a DM-RS sequence.

49. The method of claim 43:
wherein the generating the DM-RS sequence associated with the determined PQL indicator comprises retrieving a PQL parameter set using the determined PQL indicator;
wherein the retrieved PQL parameter set includes a DM-RS sequence index that can be used as a seed to generate the DM-RS sequence.

50. An Evolved Node B (eNB) in a wireless communications network, the eNB configured with one or more Physical Downlink Shared Channel (PDSCH) Resource Element (RE) Mapping and Quasi-Co-Location (PQL) indicators, the eNB comprising:
a transceiver configured to communicate with a user equipment (UE);
memory for storing data;
one or more processors configured to:
determine a PQL indicator for the UE, wherein a UE-specific association is provided between the PQL indicator and one or more demodulation reference signal (DM-RS) sequences;
generate one of the one or more DM-RS sequences associated with the determined PQL indicator; and
transmit the PQL indicator and the generated DM-RS sequence to the UE.
